(19) United States
(12) Patent Application Publication
(10) Pub. No.: US 2025/0317778 A1
(43) Pub. Date: Oct. 9, 2025

(54) METHOD, APPARATUS AND COMPUTER PROGRAM

(71) Applicant: Nokia Technologies Oy, Espoo (FI)

(72) Inventors: Jani-Pekka KAINULAINEN, Cambridge (GB); Riikka Karoliina DIMNIK, Espoo (FI); Tero HENTTONEN, Espoo (FI); Lars DALSGAARD, Oulu (FI); Matti Juhani KANGAS, Oulu (FI); Jarkko Tuomo KOSKELA, Oulu (FI); Ali KARIMIDEHKORDI, Munich (DE)

(21) Appl. No.: 19/078,915

(22) Filed: Mar. 13, 2025

(30) Foreign Application Priority Data
Apr. 8, 2024 (GB) 2405007.2

(51) Int. Cl. H04W 24/10; H04L 5/00; H04W 74/0833; H04W 76/19; H04W 76/20

(52) U.S. Cl. CPC H04W 24/10; H04L 5/0051; H04W 74/0833; H04W 76/19; H04W 76/20

(57) ABSTRACT

There is provided a communication device comprising: means for obtaining a value for an uncertainty time, and means for performing at least one measurement on at least one reference signal. The communication device also comprises: means for determining whether to include the at least one measurement in a report based on a value for a validity time and the value for the uncertainty time, and means for, based on the determining, providing, to a network node, the report comprising the at least one measurement.

### TECHNICAL FIELD

Various examples of this disclosure relate to methods, apparatuses, and computer programs for a communication network.

### BACKGROUND

A communication network can be seen as a facility that enables communications between two or more communication devices, or provides communication devices access to a data network. A mobile or wireless communication network is one example of a communication network. A communication device may be provided with a service by an application server.

Such communication networks operate in accordance with standards such as those provided by 3GPP (Third Generation Partnership Project) or ETSI (European Telecommunications Standards Institute). Examples of standards are the so-called 5G (5th Generation) standards provided by 3GPP.

### SUMMARY

Some examples of this disclosure will be described with respect to certain aspects. These aspects are not intended to indicate key or essential features of the embodiments of this disclosure, nor are they intended to be used to limit the scope thereof. Other features, aspects, and elements will be readily apparent to a person skilled in the art in view of this disclosure. For example, it should be appreciated that further aspects may be provided by the combination of any two or more of the various aspects described below.

According to an aspect, there is provided a communication device comprising: means for obtaining a value for an uncertainty time; means for performing at least one measurement on at least one reference signal; means for determining whether to include the at least one measurement in a report based on a value for a validity time and the value for the uncertainty time; and means for, based on the determining, providing, to a network node, the report comprising the at least one measurement.

In some examples, the at least one measurement is performed while the communication device is in one of: a radio resource control, RRC, idle mode, a RRC inactive mode, or a RRC connected mode.

In some examples, the communication device comprises: means for receiving, from the network node, the value for the validity time.

In some examples, the report comprising the at least one measurement is provided to the network node based on determining that the at least one measurement was performed within a time duration before a transmission, wherein the time duration comprises the value for a validity time added to the value for the uncertainty time.

In some examples, the transmission is performed by the communication device and comprises one of: a preamble transmission for RRC resume, a preamble transmission for RRC setup request, a msg1 transmission, a physical random access channel transmission, or a random access channel preamble transmission.

In some examples, the preamble transmission is performed on a physical random access channel.

In some examples, the value for the uncertainty time is representative of a time duration from a paging to a preamble transmission for the RRC resume or the RRC setup request performed by the communication device.

In some examples, the value for the uncertainty time is representative of a time duration from a paging to a preamble transmission for the RRC resume or the RRC setup request that is successfully performed by the communication device.

In some examples, the value for the uncertainty time is representative of a time duration from a paging to a response message for the RRC resume or the RRC setup request received by the communication device.

In some examples, the value for the uncertainty time is a pre-determined time value.

In some examples, the pre-determined time value is one of the following: 20 milliseconds, 40 milliseconds, or 1 second.

In some examples, the value for the uncertainty time is variable and is based on configured paging occasions for the communication device.

In some examples, the means for obtaining the value for the uncertainty time comprises: means for determining the value for the uncertainty time based on a measurement periodicity, wherein the measurement periodicity is associated with measurements performed on reference signals by the communication device.

In some examples, the means for obtaining the value for the uncertainty time comprises: means for retrieving the value for the uncertainty time from a memory that is accessible to the communication device.

In some examples, the value for the uncertainty time is dependent on discontinuous reception cycle length.

In some examples, the value for the uncertainty time is obtained during a mobile-originating initiated session, or during a mobile-terminating initiated session.

According to an aspect, there is provided a method performed by a communication device, the method comprising: obtaining a value for an uncertainty time; performing at least one measurement on at least one reference signal; determining whether to include the at least one measurement in a report based on a value for a validity time and the value for the uncertainty time; and based on the determining, providing, to a network node, the report comprising the at least one measurement.

In some examples, the at least one measurement is performed while the communication device is in one of: a radio resource control, RRC, idle mode, a RRC inactive mode, or a RRC connected mode.

In some examples, the method comprises: receiving, from the network node, the value for the validity time.

In some examples, the report comprising the at least one measurement is provided to the network node based on determining that the at least one measurement was performed within a time duration before a transmission, wherein the time duration comprises the value for a validity time added to the value for the uncertainty time.

In some examples, the transmission is performed by the communication device and comprises one of: a preamble transmission for RRC resume, a preamble transmission for RRC setup request, a msg1 transmission, a physical random access channel transmission, or a random access channel preamble transmission.

In some examples, the preamble transmission is performed on a physical random access channel.

In some examples, the value for the uncertainty time is representative of a time duration from a paging to a preamble transmission for the RRC resume or the RRC setup request performed by the communication device.

In some examples, the value for the uncertainty time is representative of a time duration from a paging to a preamble transmission for the RRC resume or the RRC setup request that is successfully performed by the communication device.

In some examples, the value for the uncertainty time is representative of a time duration from a paging to a response message for the RRC resume or the RRC setup request received by the communication device.

In some examples, the value for the uncertainty time is a pre-determined time value.

In some examples, the pre-determined time value is one of the following: 20 milliseconds, 40 milliseconds, or 1 second.

In some examples, the value for the uncertainty time is variable and is based on configured paging occasions for the communication device.

In some examples, the obtaining the value for the uncertainty time comprises: determining the value for the uncertainty time based on a measurement periodicity, wherein the measurement periodicity is associated with measurements performed on reference signals by the communication device.

In some examples, the communication device is a user equipment.

According to an aspect, there is provided an apparatus comprising: at least one processor, and at least one memory storing instructions that, when executed by the at least one processor, cause the apparatus to perform: obtaining a value for an uncertainty time; performing at least one measurement on at least one reference signal; determining whether to include the at least one measurement in a report based on a value for a validity time and the value for the uncertainty time; and based on the determining, providing, to a network node, the report comprising the at least one measurement.

In some examples, the at least one measurement is performed while the communication device is in one of: a radio resource control, RRC, idle mode, a RRC inactive mode, or a RRC connected mode.

In some examples, the apparatus is caused to perform: receiving, from the network node, the value for the validity time.

In some examples, the report comprising the at least one measurement is provided to the network node based on determining that the at least one measurement was performed within a time duration before a transmission, wherein the time duration comprises the value for a validity time added to the value for the uncertainty time.

In some examples, the transmission is performed by the communication device and comprises one of: a preamble transmission for RRC resume, a preamble transmission for RRC setup request, a msg1 transmission, a physical random access channel transmission, or a random access channel preamble transmission.

In some examples, the preamble transmission is performed on a physical random access channel.

In some examples, the value for the uncertainty time is representative of a time duration from a paging to a preamble transmission for the RRC resume or the RRC setup request performed by the communication device.

In some examples, the value for the uncertainty time is representative of a time duration from a paging to a preamble transmission for the RRC resume or the RRC setup request that is successfully performed by the communication device.

In some examples, the value for the uncertainty time is representative of a time duration from a paging to a response message for the RRC resume or the RRC setup request received by the communication device.

In some examples, the value for the uncertainty time is a pre-determined time value.

In some examples, the pre-determined time value is one of the following: 20 milliseconds, 40 milliseconds, or 1 second.

In some examples, the value for the uncertainty time is variable and is based on configured paging occasions for the communication device.

In some examples, the obtaining the value for the uncertainty time comprises: determining the value for the uncertainty time based on a measurement periodicity, wherein the measurement periodicity is associated with measurements performed on reference signals by the communication device.

According to an aspect, there is provided an apparatus comprising: circuitry configured to perform: obtaining a value for an uncertainty time; circuitry configured to perform: performing at least one measurement on at least one reference signal; circuitry configured to perform: determining whether to include the at least one measurement in a report based on a value for a validity time and the value for the uncertainty time; and circuitry configured to perform: based on the determining, providing, to a network node, the report comprising the at 10 least one measurement.

According to an aspect, there is provided a computer program comprising instructions, which when executed by an apparatus, cause the apparatus to perform at least the following: obtaining a value for an uncertainty time; performing at least one measurement on at least one reference signal; determining whether to include the at least one measurement in a report based on a value for a validity time and the value for the uncertainty time; and based on the determining, providing, to a network node, the report comprising the at least one measurement.

A computer product stored on a medium may cause an apparatus to perform the methods as described herein.

A non-transitory computer readable medium comprising program instructions, that, when executed by an apparatus, cause the apparatus to perform the methods as described herein.

An electronic device may comprise apparatus as described herein.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### LIST OF ABBREVIATIONS

AF: Application Function
AMF: Access and Mobility Management Function
AN: Access Network
BS: Base Station
CA: Carrier aggregation
CN: Core Network
DC: Dual connectivity
DL: Downlink
EMR: Early measurement reporting
eNB: eNodeB
gNB: gNodeB
LTE: Long Term Evolution
MS: Mobile Station
MO: Mobile-originating
MT: Mobile-terminating
NEF: Network Exposure Function
NG-RAN: Next Generation Radio Access Network
NF: Network Function
NR: New Radio
NRF: Network Repository Function
NW: Network
PCell: Primary cell
PCF Policy Control Function
PSCell: Primary secondary cell
PLMN: Public Land Mobile Network
RAN: Radio Access Network
RF: Radio Frequency
RRC: Radio resource control
SCell: Secondary cell
SMF: Session Management Function
UE: User Equipment
UDR: Unified Data Repository
UDM: Unified Data Management
UL: Uplink
UPF: User Plane Function
3GPP: 3^{rd} Generation Partnership Project
5G: 5^{th} Generation
5GC: 5G Core network
5G-AN: 5G Radio Access Network
5GS: 5G System

### BRIEF DESCRIPTION OF DRAWINGS

Some examples will now be described, by way of illustrative and non-limiting example only, with reference to the accompanying drawings in which:

FIG. 1 shows a schematic representation of a 5G communication system;

FIG. 2 shows a schematic representation of an apparatus for the 5G communication system of FIG. 1;

FIG. 3 shows a schematic representation of a communication device;

FIG. 4 shows a signalling and operations diagram between a communication device, a primary cell, and a target secondary cell for early measurement reporting;

FIG. 5 shows a schematic representation of measurements being performed by a communication device over a period of time;

FIG. 6 shows a schematic representation of valid and non-valid measurements that are being performed by a communication device over a period of time;

FIG. 7 shows a signalling and operations diagram between a communication device and a network node;

FIG. 8 shows an example method flow diagram performed by an apparatus; and

FIG. 9 shows a schematic representation of a non-volatile memory medium storing instructions which when executed by a processor allow a processor to perform one or more of the steps of the method of FIG. 8.

### DETAILED DESCRIPTION

In 3GPP Rel-18, RAN4 introduced enhancement to Rel-16 radio resource control (RRC) idle and RRC inactive mode carrier aggregation (CA)/dual connectivity (DC) early measurement reporting (EMR) at secondary cell (SCell) connection setup by enabling opportunities for the UE to report RRC idle/inactive mode measurements at RRC connection setup compared to Rel-16 EMR. EMR is a feature that was first introduced in Rel-16 to improve the setup of CA and DC by enhancing NR to support EMR reports during the transition from the RRC idle/inactive to connected state, in parallel with the resume complete message. This is possible in NR because when the UE is suspended, the UE receives the security parameters needed to encrypt a sensitive measurement report. When security is activated, early measurement reports may be multiplexed with a resume request or multiplexed with a resume complete message (e.g., when requested by the radio access network in the resume message).

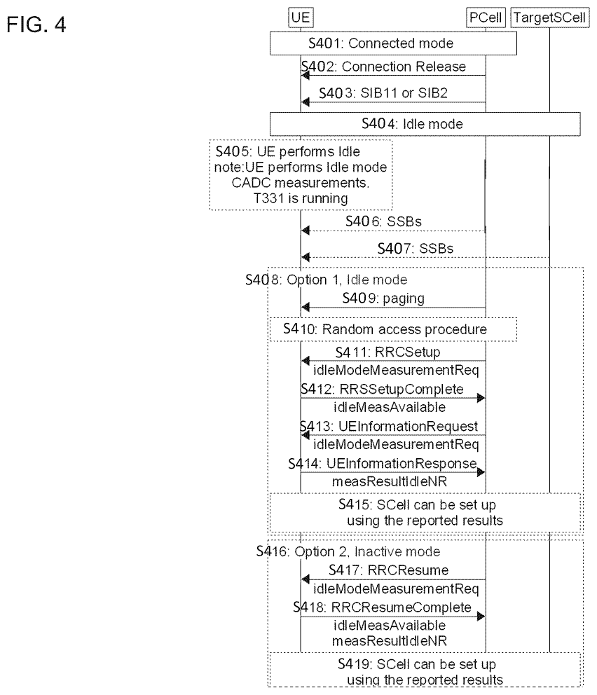

3GPP Rel-16 RRC idle/inactive mode CA/DC early measurement reporting means that a UE is configured to perform measurements in RRC idle/inactive mode to enable faster CA or DC secondary cell (SCell) or primary secondary cell (PSCell) setup once the RRC connection is restored. The measurement time may be restricted by a timer (e.g., T331) that starts once the UE enters RRC idle/inactive mode, and the measurement requirements for the UE apply only during the timer. An example of a procedure for Rel-16 EMR measurements is shown in FIG. 4.

FIG. 4 shows a signalling and operations diagram between a communication device, a primary cell, and a target secondary cell for early measurement reporting.

At S401, a UE is connected to a PCell, and is in RRC connected mode.

At S402, the PCell sends a connection release message to the UE.

At S403, the PCell sends system information block (SIB) 11 or SIB2 to the UE.

At S404, the UE is in RRC idle mode. In other examples, the UE is in RRC inactive mode.

At S405, the UE performs measurements (while in RRC idle/inactive mode). A timer (e.g., T331) may start to run. The timer may start when the UE enters RRC idle mode. The measurements may be carrier aggregation dual connectivity (CADC) measurements.

At S406, the PCell sends reference signals to the UE. For example, the reference signals may be synchronisation signal blocks (SSBs).

At S407, a target secondary cell (SCell) sends reference signals to the UE. For example, the reference signals may be SSBs.

S408 to S415 are part of a first alternative ('option 1′). S416 to S419 are part of a second alternative ('option 2′). Option 1 is related to RRC idle mode for the UE. Option 2 is related to RRC inactive mode for the UE.

At S408, for option 1 (idle mode):

At S409, the PCell sends a paging to the UE.

At S410, a random access procedure between the UE and the PCell takes place.

At S411, the PCell sends, to the UE, a message related to idle mode measurements.

At S412, the UE sends, to the PCell, an indication that idle mode measurements are available.

At S413, the PCell sends, to the UE, a request for the idle mode measurements.

At S414, the UE sends, to the PCell, the idle mode measurements.

At S415, based on the idle mode measurements, a connection between the UE and the SCell is established.

At S416, for option 2 (inactive mode):

At S417, the PCell sends, to the UE, an RRC resume message with a request related to idle mode measurements. The PCell may request idle mode measurements from the UE.

At S418, the UE sends, to the PCell, the idle mode measurements.

At S419, based on the idle mode measurements, a connection between the UE and the SCell is established.

When a UE (e.g., the UE of FIG. 4) is entering the RRC connected mode, the network may request the UE to provide available measurements using, for example, one of the following messages: a UEInformationRequest, or a RRCResume.

The network may request the UE measurement results using one of these two messages by including the ‘idleModeMeasurementReq’ information element (IE) in either ‘UEInformationRequest’ or ‘RRCResume’. This field (idleModeMeasurementReq) indicates that the UE shall report the results of measurements during idle/inactive state, if available at the UE, to the network either in the RRCResumeComplete message or UEInformationResponse message (or IE).

The UE may indicate, during the connection establishment, that the UE has idle mode measurements available for reporting for example:
IDLE: RRCSetupComplete (idleMeasAvailable)
INACTIVE: RRCResumeComplete (idleMeasAvailable)

The ‘idleMeasAvailable’ indicates that the UE has idle/inactive measurement report available. The measurement results may be included in the RRCResumeComplete message, for example, using ‘measResultIdleNR’ in the RRCResumeComplete message. When the UE indicates ‘idleMeasAvailable’ in the RRCSetupComplete message, the network will request the results using the UEInformationRequest message when the network want to retrieve the measurement results.

When the network requests the measurements from the UE in the RRCResume message using ‘idleModeMeasurementReq’ IE and the UE has no measurements to report, the UE may reply in the RRCResumeComplete message with ‘idleMeasAvailable’, but with no measurement results.

In Rel-18, there has been work on SCell setup enhancements that has been led by RAN4. RAN4 divided the EMR work into two parts depending on UE capability to support additional measurements. This is indicated by capability which has two “features”: “existing measurement solution” and “enhanced measurement solution”.

The difference between “existing measurement solution” and “enhanced measurement solution” is in the assumption of whether UE supports performing measurements starting from, and during RRC Setup/Resume procedure.

a. [existing-measurement-solution-r18] capability: Assumption of the reported measurements is that UE does not perform new measurements starting from, and during RRC Setup/Resume procedure and while in RRC connected mode. Time-based validation criteria are used.

An agreed enhancement in 3GPP Rel-18 is to allow the UE to also report Rel-16 EMR measurements after timer (e.g., T331) expiry and to also report cell re-selection measurements. This was allowed by introducing a validity check of the “existing measurements” before reporting. The existing measurements are measurements that a UE performed before connection setup while in RRC idle or RRC inactive mode, or performed in RRC connected mode before the UE entered idle/inactive mode. An existing measurement assumption may be that UE does not perform additional measurements starting from msg1 or RRC setup or resume. The validity check may comprise, at RRC connection setup, the UE verifying that the idle/inactive mode measurements it has available are performed within time period (e.g., time value ‘X’) before a Msg1 transmission of an RRC connection setup. The Msg1 is the first message (preamble transmission) of a random access procedure. The terms ‘msg1’, ‘MSG1’, ‘MSG-1’ may be used interchangeably in the following examples.

The measurements are also to fulfil accuracy requirements at the time of measurement to be allowed to be included in a report. The time value ‘X’ has been agreed to be a network-configurable value.

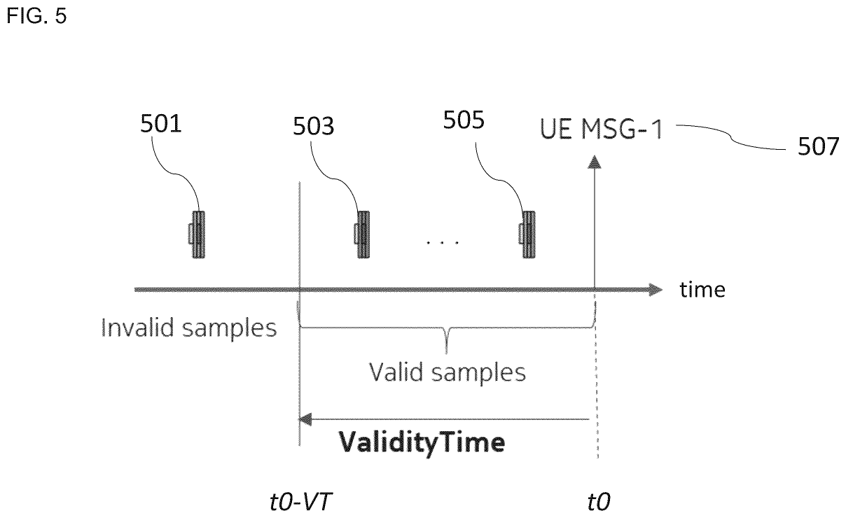

In this manner, a measurement report for (fast) CA/DC setup specifies that the reported measurements to be included in the report will be performed within X seconds (also referred to as validity time or ValidityTime) before msg1 transmission. Measurements that fall outside of the X seconds (or ValidityTime) are not allowed to be included in the report. This is depicted in FIG. 5.

FIG. 5 shows a schematic representation of measurements being performed by a communication device over a period of time.

A first measurement 501, a second measurement 503 and a third measurement 505 are depicted. The first 501, second 503, and third measurements 505 are performed by a UE (not shown). The measurements may be performed on reference signals (e.g., SSBs and/or CSI-RSs) received by the UE. The first 501, second 503, and third measurements 505 may be performed while the UE is in RRC idle mode. The first measurement 501 is performed first (in time), and the third measurement 505 is performed last by the UE.

At time 0, t0, the UE transmits a MSG-1 507 of a random access procedure in order to connect to the network (i.e., to move to RRC connected state). Measurements that are ‘valid’, and are allowed to be included in a measurement report, are determined based on the MSG-1 transmission and the Validity Time. The time duration of Validity Time is calculated back from t0 (i.e., the time of MSG-1 transmission). Stated differently, measurements that were performed by the UE within ValidityTime from t0 are valid. This is labelled in FIG. 5 as t0-VT.

The second measurement 503 and the third measurement 505 are between t0-VT and t0, meaning that they are valid. The first measurement 501 falls outside of this time window and so it is an invalid measurement.

The validity of the measurements may be tested by utilising an apparatus for testing (herein referred to as a ‘tester’). The tester may be configured to transmit to and/or receive signals from a UE, and may mimic a cellular system (e.g., a 5G system). The validity may be tested by defining a first threshold ('threshold 1′) that the tester transmits to a UE. The threshold 1 may be in the form of a signal that is transmitted, wherein the signal is detectable by the UE. The UE may measure the signal, whereby measurements of the signal could be suitable for a measurement report.

When the tester signal level is changed to a second threshold ('threshold 2′), then this signal level is detectable by the UE. The characteristics of the signal associated with ‘threshold 1’ and ‘threshold 2’ are different. For example, the power of the signals may be different. In this manner, when the UE measures the signal associated with threshold 2, the results of measurements performed by the UE will change compared to measurements performed in the signal associated with threshold 1. The measurement results will reflect the threshold 2 in a measurement report.

When considering the measurements for a report, the measurements need to be performed within a ValidityTime, wherein the time evaluation starts from MSG-1. This means that the samples are evaluated backwards in time, towards when a first measurement was performed. When setting the signal level on tester, the tester may only go forward in time. This creates a problem that when the tester sets the signal level from threshold 1 to threshold 2, the tester needs to keep the signal level at threshold 2 for the time of validity duration (ValidityTime).

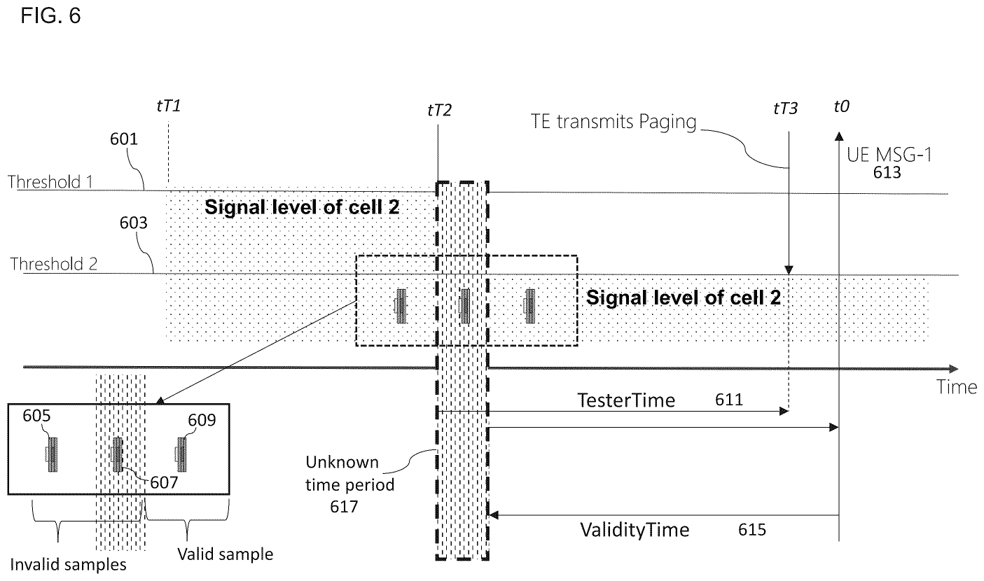

The time that the MSG-1 will be transmitted by the UE is not specified. The tester may use a paging occasion to page the UE, but it will be an unspecified length of time before MSG-1 is transmitted by the UE. Therefore, the tester is not able to accurately test that the measurements have been measured within Validity Time. Furthermore, in scenarios whereby a session is mobile originated (MO)-initiated, there is not a paging to consider (i.e., preamble transmission (msg₁) will occur without paging). This problem is depicted in FIG. 6.

FIG. 6 shows a schematic representation of valid and non-valid measurements that are being performed by a communication device over a period of time.

There is depicted a first signal 601 that is being transmitted by a tester (not shown) which is associated with a first threshold and is labelled ‘threshold 1’ in FIG. 6. The tester is a test equipment that is able to simulate gNB and radio conditions and is controllable by a test case. A second signal 603 that is being transmitted by the tester which is associated with a second threshold and is labelled as ‘threshold 2’. From time tT1 to tT2, the tester is transmitting the first signal 601 (threshold 1) to a UE (not shown). At time tT2, the tester starts to transmit the second signal 603 (threshold 2). At least one characteristic of the second signal 603 is different compared to the first signal 601, such that the UE receiving the signals 601, 603 is able to distinguish between them.

Time tT2 is the point in time when the signal level is set, by the tester, to threshold 2. Time tT2 is also the point in time when the tester starts the time (or timer) for testing the measurements being performed by the UE and being included in a report. The time (or timer) for testing is referred to as ‘TesterTime’ in FIG. 6.

A first measurement 605 is measured by the UE while the tester is transmitting the first signal 601. A second 607 and a third measurement 609 are performed while the tester is transmitting the second signal 603. In this manner, the first measurement 605 is associated with the first signal 601, and the second 607 and third measurements 609 are associated with the second signal 603.

After the time duration of a Validity Time after the switch to the second signal 603, the tester transmits a paging to the UE. In this manner, the tester is considered to start the testing time when the second signal 603 is transmitted (i.e., at tT2), to when the paging is transmitted (at time tT3). This duration of time (from tT2 to tT3) is labelled as TesterTime 611

The UE transmits an msg1 613 at time t0. The validity of the measurements is determined based on the time duration of ValidityTime 615 which is calculated backwards from time t0. Based on time t0 and Validity Time 615, only the third measurement 609 is valid. However, it is both the second measurement 607 and the third measurement 609 which would be considered to be valid by the tester according to the TesterTime 611. This is due to an unknown time period 617. The unknown time period 617 is due to the unknown time duration between the paging at tT3 and transmission of msg1 at t0.

Therefore, this leads to the problem of a tester not being able to accurately test whether measurements samples have been measured within the ValidityTime or not.

One or more of the problems identified above are addressed in one or more of the examples described below.

In examples, there is an apparatus (e.g., a communication device) that obtains a value for an uncertainty time, and performs at least one measurement on at least one reference signal. The apparatus determines whether to include the at least one measurement in a report based on a value for a validity time and the value for the uncertainty time. Based on the determining, the apparatus provides, to a network node (e.g., a base station, primary cell, etc), the report comprising the at least one measurement.

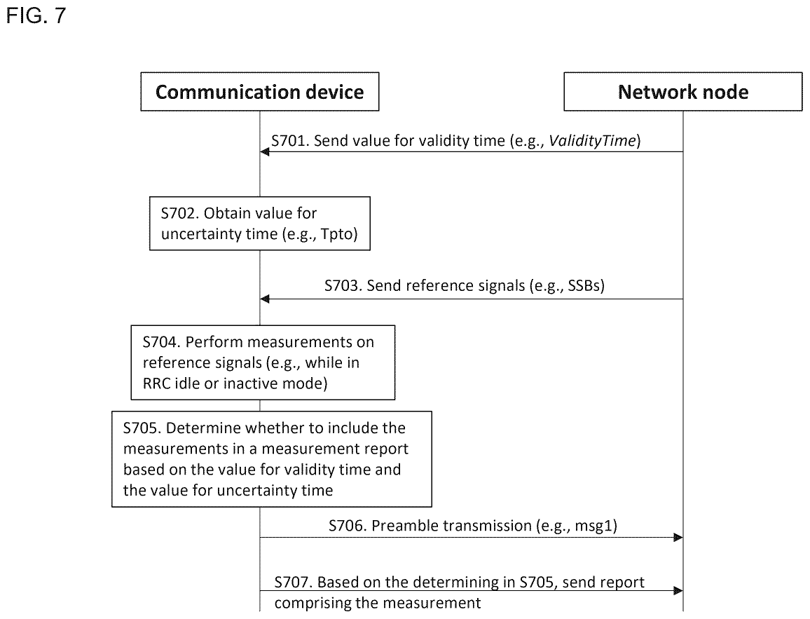

This example alongside others will be described in more detail below, with reference to FIGS. 7 to 9.

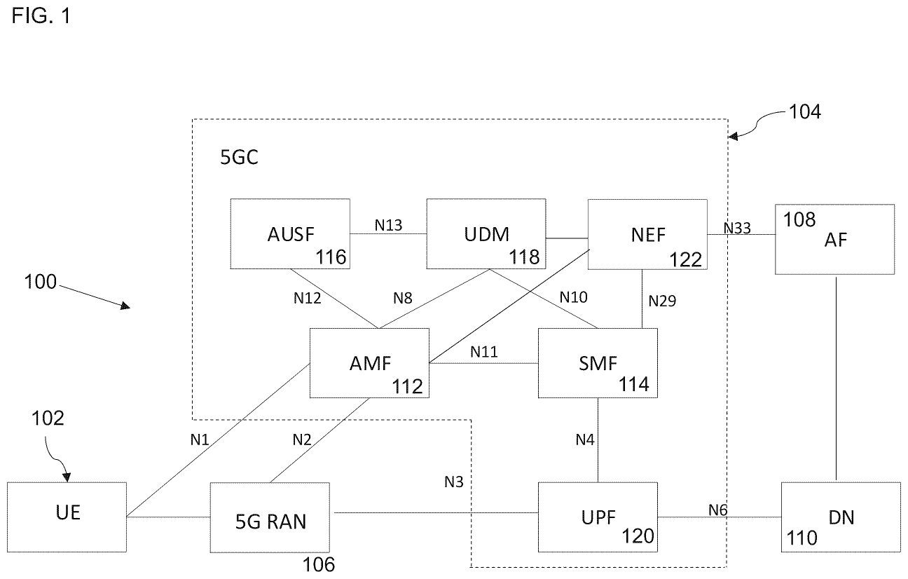

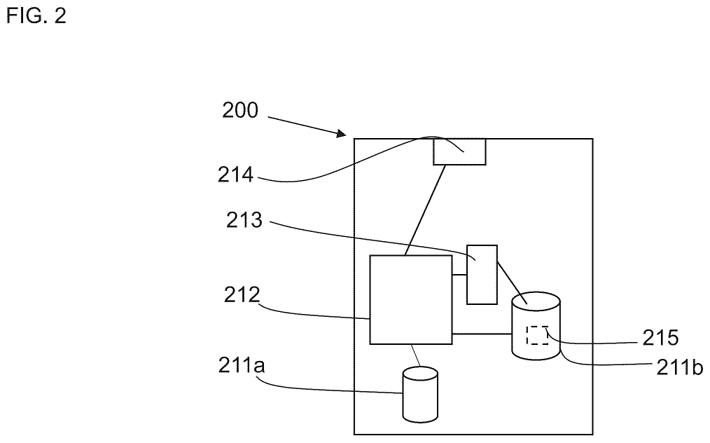

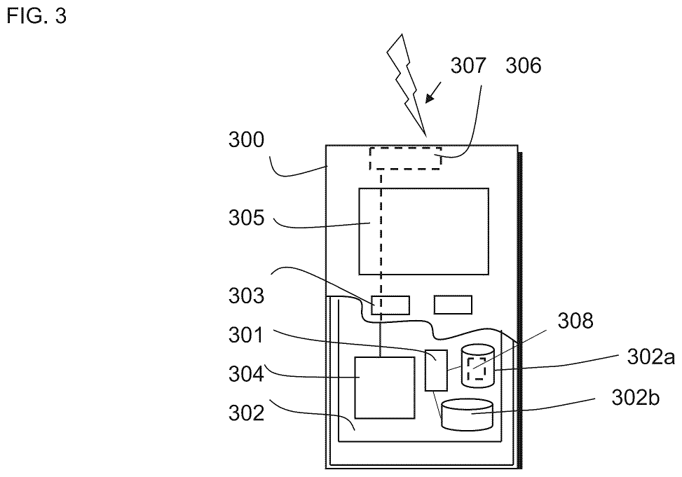

Before explaining the examples above in greater detail, an example communication device (as shown in FIG. 3) that is capable performing measurements and determining whether to include the measurements in a report. The communication device is part of a communication system (as shown in FIG. 1). The communication device is able to communicate with one or more of the entities of the communication system (as shown in FIG. 1) via an apparatus (as shown in FIG. 2), which may be part of/comprised in a network node (e.g., base station). A network node and communication device may communicate with each other, such that the communication device is able to reports with measurements to the network node.

Certain general aspects of the communication system and the communication device are briefly explained with reference to FIGS. 1 to 3 to assist in understanding the technology underlying the described examples.

FIG. 1 shows a schematic representation of a 5G communication system 100. The wireless communication system 100 comprises one or more communication devices 102 such as user equipments (UEs), user devices, or terminals. The wireless communication system 100 comprises a 5G system (5GS). The 5GS comprises a 5G radio access network (5G-RAN) 106, a 5G core network (5GC) 104 comprising one or more network functions (NF), one or more application functions (AFs) 108, and one or more data networks (DNs) 110.

The 5G-RAN 106 may comprise one or more gNodeB (gNB) distributed unit (DU) functions connected to one or more gNodeB (gNB) centralized unit (CU) functions.

The 5GC 104 comprises an access and mobility management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown below may be applicable to 3GPP 5G standards. However, some examples may also be applicable to 5G-advanced, 4G, 3G and other 3GPP standards.

In a wireless communication system 100, such as that shown in FIG. 1, communication devices 102, such as for example, terminals, user apparatuses, user equipments (UE), and/or machine-type communication devices are provided with wireless access via at least one base station or similar wireless transmitting and/or receiving node or point. The communication device 102 is provided with an appropriate signal receiving and transmitting apparatus for enabling communications, for example enabling access to a communication network or communications directly with other devices. The communication device 102 may access a carrier provided by a base station or access point, and transmit and/or receive communications on the carrier.

FIG. 2 illustrates an example of an apparatus 200. The apparatus 200 may be for the 5G communication system of FIG. 1. The apparatus 200 may be for controlling a function of one or more network entities and/or network functions, such as the entities of the 5G-RAN or the 5GC as illustrated on FIG. 1. The apparatus 200 comprises at least one random access memory (RAM) 211a, at least one read only memory (ROM) 211b, at least one processor 212, 213 and an input/output interface 214. The at least one processor 212, 213 is coupled to the RAM 211a and the ROM 211b. The at least one processor 212, 213 may be configured to execute an appropriate software code 215. The software code 215 may for example allow to perform one or more steps to perform one or more of the present aspects or examples. The software code 215 may be stored in the ROM 211b. The apparatus 200 may be interconnected with another apparatus 200 controlling another entity/function of the 5G-AN or the 5GC. In some examples, apparatus 200 may be configured to provide one or more functions of the 5G-AN or the 5GC. For example, apparatus 200 may be configured to perform at least some functionality of a particular function of the 5G-AN or the 5GC. For example, apparatus 200 may be configured to operate as a particular function of the 5G-AN or the 5GC. In alternative examples, apparatus 200 may be configured to perform at least some functionality of two or more functions of the 5G-AN and/or the 5GC. For example, apparatus 200 may be configured to operate as two or more functions of the 5G-AN and/or the 5GC. The apparatus 200 may comprise one or more circuits, or circuitry (not shown) which may be configured to perform one or more of the present aspects or examples.

FIG. 3 illustrates an example of a communication device 300. The communication device 300 may be similar to the communication device 102 illustrated in FIG. 1. The communication device 300 may be provided by any device capable of sending and receiving radio signals. Non-limiting examples of a communication device 300 are a user equipment, a terminal, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device, or a terrestrial/maritime/aerial vehicle such as a car, a truck, a boat, an air plane, or a drone, or any combinations of these or the like. The communication device 300 may provide, for example, communication of data for carrying communications. The communications may be one or more of voice, electronic mail (email), text message, multimedia, data, machine data and so on.

The communication device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided for example by means of a radio part and associated antenna arrangement. The antenna arrangement may be arranged internally or externally to the mobile device.

The communication device 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a. The communication device 300 may comprise one or more circuits, or circuitry (not shown) which may be configured to perform one or more of the present aspects or examples.

The processor, storage and other relevant control apparatus may be provided on an appropriate circuit board and/or in chipsets. This feature is denoted by reference 304. The communication device may optionally have a user interface such as keypad 305, touch sensitive screen or pad, combinations thereof or the like. Optionally one or more of a display, a speaker and a microphone may be provided depending on the type of the device.

In some examples, the length of time that a measurement may be included (by a communication device) in a report for a network takes into account an uncertainty that is associated with a paging reception and preamble transmission (e.g., msg1 transmission).

The communication device determines whether to include the measurement in the report based on a value for a validity time (e.g., ValidityTime) and a value for an uncertainty time.

The value for the uncertainty time may be referred to as a ‘preamble transmission occasion (PTO)’ uncertainty, or uncertainty associated with MSG-1 transmission, in some examples. The value for the uncertainty time will be referred to as T_{PTO} herein. It should be understood that any suitable name or representation may be used for the value for the uncertainty time. For example, uncertainty time value, time value for uncertainty, time duration for uncertainty, first time value, or adjusting (considering) time value, etc. T_{PTO} is time value (e.g., 20 milliseconds (ms), 40 ms or 1 second(s)). In some examples, the uncertainty time (T_{PTO}) may be determined (e.g., by a communication device) based on measurement periodicity (e.g., SSB periodicity). For example, 40 ms may be selected to allow a communication device to include 2 SSB samples when the SSB periodicity is 20 ms or 1 sample if the periodicity is 40 ms. The value of T_{PTO} may be defined such that most of the practical MSG-1 transmission occasions are included within this time (e.g., time is more than a maximum time from paging to MSG-1 transmission).

The value for the validity time will be referred to as ‘ValidityTime’ herein. In other examples, any suitable name or representation may be used. For example, time value, validity time value, time duration for validity, second time value, etc. ValidityTime is a time value (e.g., 5 s, 10 s, 20 s, 50 s, or 100 s).

When it is determined that the measurement was performed within a time duration before the preamble transmission, the measurement is included in the report for the network. The first time duration is the value for a validity time added to the value for the uncertainty time (i.e., first time duration=the value for a validity time+the value for the uncertainty time). The communication device then provides the report to the network. The report may be provided at a first reporting occasion, e.g. RRCSetup or RRCresume complete message, or UE information response.

This means that a communication device (e.g., UE) is allowed to include measurements (or measurement samples) which are performed within a ValidityTime+T_{PTO} before Msg1 transmission. The T_{PTO} may be considered to be the uncertainty (time) associated with the preamble/MSG-1 transmission.

When mobile terminated (MT)-initiated sessions are considered, the T_{PTO} may be considered to be the uncertainty counted from a paging occasion to a first preamble transmission (successful or non-successful). This allows the test equipment to accurately set the X value (or value for ValidityTime) while allowing UE to perform measurements during the uncertainty time. Hence the X value and T_{PTO} becomes detectable by the tester (e.g., using the testing setup of FIG. 6).

When both MO-initiated and MT-initiated calls are considered, the ValidityTime is counted from a first successful Msg1 transmission. The T_{PTO} will added to the ValidityTime for accurate determination of valid measurements. For MT-initiated sessions, this means that the ValidityTime is counted from the paging occasion, while for MO-initiated sessions there may be an additional time added to the overall network-configured time.

The T_{PTO} may be defined as minimum required time at the communication device which means most of the successful Msg1 transmission may be within this time. Therefore, the T_{PTO} feature is able to be reliably tested with a tester apparatus.

FIG. 7 shows a signalling and operations diagram between a communication device and a network node.

At S701, the network node sends (or provides), to the communication device, information indicating a value for a validity time (e.g., ValidityTime). In other examples, rather than receiving the information the indicating a value for a validity time, the ValidityTime is pre-configured at the communication device.

The value for the validity time may be associated with early measurement reporting (EMR). The value for the validity time may be associated with reporting of existing measurements. The value for the validity time may be associated with CA and/or DC. The value for the validity time may be associated with setup of ‘fast’ CA and/or DC.

At S702, the communication device obtains a value for an uncertainty time (e.g., T_{PTO}). T_{PTO} may be preconfigured at the communication device. The obtaining may comprise retrieving the T_{PTO} from a memory that is accessible to the communication device (e.g., the value for the uncertainty value is preconfigured in the communication device). In other examples, the T_{PTO} is explicitly indicated from the network node, or another device. Stated differently, the network node provides information, to the communication device, which indicates the value for T_{PTO}. Alternatively, in other examples, the communication device may determine the T_{PTO}. For example, the communication device may determine T_{PTO} by measuring the time differences between the transmission of a MSG-1 and reception of a paging signal. In other examples, the communication device may determine T_{PTO} based on measurement periodicity (of reference signals).

The value for the uncertainty time may be associated with early measurement reporting (EMR). The value for the uncertainty time may be associated with reporting of existing measurements. The value for the uncertainty time may be associated with CA and/or DC. The value for the uncertainty time may be associated with setup of ‘fast’ CA and/or DC.

At S703, the network node sends reference signals (e.g., SSBs and/or channel state information reference signals (CSI-RSs)). The communication device is able to receive the reference signals. The network node may be a PCell in some examples. Other network nodes (e.g., neighbouring gNB(s)) may also send reference signals that the communication device is able to receive. At least one of the other network nodes may be a target SCell, for example.

At S704, the communication device performs at least one measurement on the reference signals (e.g., SSBs or CSI-RSs) received from the network node. The communication device may also perform at least one further measurement on reference signals from other network nodes.

The communication device may perform the at least one measurement while in an RRC idle state or an RRC inactive mode. In other examples, the communication device may perform the at least one measurement while in an RRC connected mode.

At S705, the communication device determines whether to include the at least one measurement in a report based on the value for validity time and the value for uncertainty time.

The communication device may determine a first time duration by adding the value for validity time and the value for uncertainty time (i.e., first time duration=the value for validity time+the value for uncertainty time).

When a measurement of the at least one measurement has been performed within the first time duration before a preamble transmission performed by the communication device, then the measurement is allowed to be included in the report. Stated differently, the measurement is determined to be valid. In some examples, in order to be allowed to be included in the report, the measurement should also satisfy at least one measurement accuracy requirement. In this example, it is assumed that the measurement does satisfy the at least one measurement accuracy requirement.

When a plurality of measurements (or measurement samples) are collected/performed by the communication device, then the communication device determines whether each of the plurality of measurements may be included in a report (determine whether each measurement is valid).

In this example, it is assumed that the at least one measurement is determined to be valid (i.e., allowed to be included in a report).

At S706, the communication device sends, to the network node, a preamble transmission. The preamble transmission may be a msg1 transmission for a random access procedure (e.g., random access for one of a number of purposes). The msg1 (or preamble transmission) may be sent using a physical random access channel (PRACH). Stated differently, the communication device transmits the preamble on the PRACH.

At S707, based on the determining in S705, the communication device sends, to the network node, the report comprising the at least one measurement (which is valid in this example). In this example, it is assumed that the at least one measurement included in the report was performed within the time duration before the preamble transmission (e.g., within the time duration before S706). In some examples, the report that is sent to the network node comprises a plurality of measurements. The plurality of measurements may comprise at least one of: measurements related to the network node, or measurements related to other network nodes.

In some examples, based on the measurements reported to the network node, a connection between the communication device and a secondary cell may be established. This connection may be established when the communication device has performed measurements on reference signals transmitted by the secondary cell.

The report may be a measurement report for CA and/or DC. The report may be a measurement report for setup of CA and/or DC. The report may be a measurement report for setup of ‘fast’ CA and/or DC.

In the example of FIG. 7, existing measurements may be measurements that the communication device performed before connection setup while in RRC idle or RRC inactive mode, or performed in RRC connected mode before the communication device entered idle/inactive mode. An assumption for existing measurements may be that the communication device refrains from performing additional measurements starting from msg1 (e.g., S706) or RRC setup or resume.

It should be understood that, in other examples, one or more of the features depicted in FIG. 7 may not be performed, or may be performed in a different order.

In this manner, a parameter or value is defined for the uncertainty associated with the msg1 transmission, which is referred to as T_{PTO}. The UE is allowed to measure during this uncertainty time, and so the ValidityTime is able to be verified.

The following examples show different ways to implement changes to the specification in the TS 38.133 specification (section 4.7.3) according to T_{PTO}, wherein the changes are marked in bold text. In the following, ‘X’ or [X] is the ValidityTime.

### EXAMPLE 1

For MT-initiated sessions:
TPTO is the uncertainty from paging to first preamble transmission occasion (e.g., msg1).
TPTO is only considered when the ValidityTime or X is configured

### 4.7.3 Measurement Report Requirements

A UE supporting [solution based on existing measurement] capability shall be able to report valid measurement results. The measurement results are considered valid if the following conditions are met:
the measurements are performed within the last [X]+T_{PTO} seconds before msg1 transmission for RRC resume/setup request, where [X] is configured by [TBD], T_{PTO} is the uncertainty from paging to first preamble transmission occasion (i.e. msg1), and
the measurement results satisfy measurement accuracy requirement at the measurement instance.
   Otherwise, the measurement results are considered invalid. The UE shall not report invalid measurement results when X is configured.
   If the [X] is not configured, UE is not required to perform validity check and the UE may report measurement results given the measurement results satisfy measurement accuracy requirement at the measurement instance.

T_{PTO} is only considered when RRC connection setup is initiated by paging message and when the [X] is configured.

### EXAMPLE 2

For a T_{PTO} value that is related to a first successful preamble transmission, and wherein the T_{PTO} is fixed to an example value (=40 ms):
T_{PTO} is the uncertainty from paging until the first successful preamble transmission occasion (e.g., msg1)
TPTO is only considered when the X is configured (included in the validity check)

### 4.7.3 Measurement Report Requirements

A UE supporting [solution based on existing measurement] capability shall be able to report valid measurement results. The measurement results are considered valid if the following conditions are met:
the measurements are performed within the last [X]+T_{PTO} seconds before msg1 transmission for RRC resume/setup request, where [X] is configured by [TBD], T_{PTO} is the uncertainty from paging to first successful preamble transmission occasion (i.e. msg1), and
the measurement results satisfy measurement accuracy requirement at the measurement instance.
   Otherwise, the measurement results are considered invalid. The UE shall not report invalid measurement results when X is configured.
   If the [X] is not configured, UE is not required to perform validity check and the UE may report measurement results given the measurement results satisfy measurement accuracy requirement at the measurement instance.

T_{PTO}=[40] ms

### EXAMPLE 3

For a T_{PTO} value that is related to a first successful preamble transmission, wherein the successful transmission is identified by Msg₂ being received by a UE. The T_{PTO} is fixed to an example value (=40 ms):
TPTO is the uncertainty from paging until the successful preamble reception occasion (e.g., msg1 is received, which the UE knows from reception of msg2)
TPTO is only considered when the X is configured (included in the validity check)

### 4.7.3 Measurement Report Requirements

A UE supporting [solution based on existing measurement] capability shall be able to report valid measurement results. The measurement results are considered valid if the following conditions are met:
the measurements are performed within the last [X]+T_{PTO} seconds before msg₁ transmission for RRC resume/setup request, where [X] is configured by [TBD], T_{PTO} is the time between first preamble transmission and the successful reception of Msg₂ from network, and
the measurement results satisfy measurement accuracy requirement at the measurement instance.
   Otherwise, the measurement results are considered invalid. The UE shall not report invalid measurement results when X is configured.
   If the [X] is not configured, UE is not required to perform validity check and the UE may report measurement results given the measurement results satisfy measurement accuracy requirement at the measurement instance.

T_{PTO}=[40] ms

### EXAMPLE 4

### 4.7.3 Measurement Report Requirements

A UE supporting [solution based on existing measurement] capability shall be able to report valid measurement results. The measurement results are considered valid if the following conditions are met:
the measurements are performed within the last [X] seconds before msg1 transmission for RRC resume/setup request, where [X] is configured by [TBD], and
the measurement results satisfy measurement accuracy requirement at the measurement instance.
   Otherwise, the measurement results are considered invalid. The UE shall not report invalid measurement results when X is configured.
   The total time UE may perform measurements when [X] is configured is the configured time [X]+T_{PTO} where the T_{PTO} is the uncertainty from paging until the first successful preamble transmission (i.e., MSG-1). T_{PTO} is only considered when RRC connection setup is initiated by paging message and when the X is configured. T_{PTO}=[40] ms.
   If the [X] is not configured, UE is not required to perform validity check and the UE may report measurement results given the measurement results satisfy measurement accuracy requirement at the measurement instance.

### EXAMPLE 5

### 4.7.3 Measurement Report Requirements

A UE supporting [solution based on existing measurement] capability shall be able to report valid measurement results. The measurement results are considered valid if the following conditions are met:
the measurements are performed within the last [X] seconds before msg1 transmission for RRC resume/setup request, where [X] is configured by [TBD], and
the measurement results satisfy measurement accuracy requirement at the measurement instance.
   Otherwise, the measurement results are considered invalid. The UE shall not report invalid measurement results when X is configured.
   The total time UE may perform measurements when [X] is configured is the configured time [X]+T_{PTO} where the T_{PTO} is the uncertainty from the first preamble transmission (i.e., MSG-1) to reception of Msg₂ from the network. T_{PTO}=[40] ms.
   If the [X] is not configured, UE is not required to perform validity check and the UE may report measurement results given the measurement results satisfy measurement accuracy requirement at the measurement instance.

### EXAMPLE 6

### 4.7.3 Measurement Report Requirements

A UE shall perform validity check and report valid measurement results
if the UE is supporting [FG-39-8] and measIdleValidityDuration-r18 is configured for carriers in measIdleCarrierListNR-r16,
if the UE is supporting [FG-39-9] and measReselectionValidityDuration-r18 is configured for carriers in measReselectionCarrierListNR-r18

The measurement results are considered valid if validity check with the following conditions is met:
the measurements are performed before MSG-1 transmission for RRC resume/setup request within the last:
   measIdleValidityDuration-r18 seconds for carriers configured in measIdleCarrierListNR-r16, and
   measReselectionValidityDuration-r18 seconds for carriers configured in measReselectionCarrierListNR-r18, and
the measurement results satisfy measurement accuracy requirement at the measurement instance.
   Otherwise, the measurement results validity check has been performed are considered invalid.

In one or more of the examples above associated with TS 38.133 specification (section 4.7.3), the time value for T_{PTO} is given as 40 ms. It should be understood that this is an example only. In other examples, the value may be higher or lower than 40 ms.

As described in the examples above, the value for the uncertainty time (e.g., T_{PTO}) may be configured to consider different time periods. For example, paging to a first preamble transmission, or paging to a first successful preamble transmission. The communication device that is configured with the value for the uncertainty time (e.g., T_{PTO}) may be unaware as to the time period considered with the value. Stated differently, the communication device may utilise only the time value of T_{PTO}, and not how it has been configured.

In some examples, the T_{PTO} is defined as a fixed time value. For example, T_{PTO} may be defined in milliseconds or seconds. An associated advantage of a fixed time value is that signalling is not needed to indicate the value to a communication device. T_{PTO} may be a fixed value of 20, 40 ms or 1 s. It should be understood that these are example time values only. In other examples, the T_{PTO} may be higher than 1 s or lower than 20 ms.

In some examples, the T_{PTO} is derived (or determined) by a communication device based on a measurement periodicity (e.g., a reference signal periodicity). The advantage of this is that the duration may contain at least a predetermined number of samples.

In some examples, the T_{PTO} is a variable value. The variable T_{PTO} may be based on configured UE paging occasion. An associated advantage of this is that the value is a realistic estimation of paging occasions.

In some examples, the T_{PTO} is dependent on discontinuous reception (DRX) cycle length. An associated advantage of this is that a communication device may wake up a receiver during these occasions.

In some examples, the T_{PTO} is included only when paging is used, and not when UE initiates MSG-1 transmission. This allows the extra time to be added when paging is used, and/or when testing the ValidityTime feature.

In some examples, the T_{PTO} is obtained during a mobile-originating initiated session, or during a mobile-terminating initiated session.

One or more of the examples described above have the advantage that an uncertainty time introduced into a system associated with paging and preamble transmission is taken into account, which means that testing of the system is more accurate. In some cases, without taking in account this uncertainty time, the ValidityTime feature for including measurements in reports cannot be tested, which means it cannot be implemented reliably according to the testing as described herein. Having non-tested features may cause unspecified and faulty behaviour in the real network deployments. As discussed above, an apparatus for testing mat not being able to accurately test whether measurements samples have been measured within a Validity Time or not. A communication device is able to obtain an uncertainty time (T_{PTO}) and use this value when determining whether to include measurements in a report for a network or not.

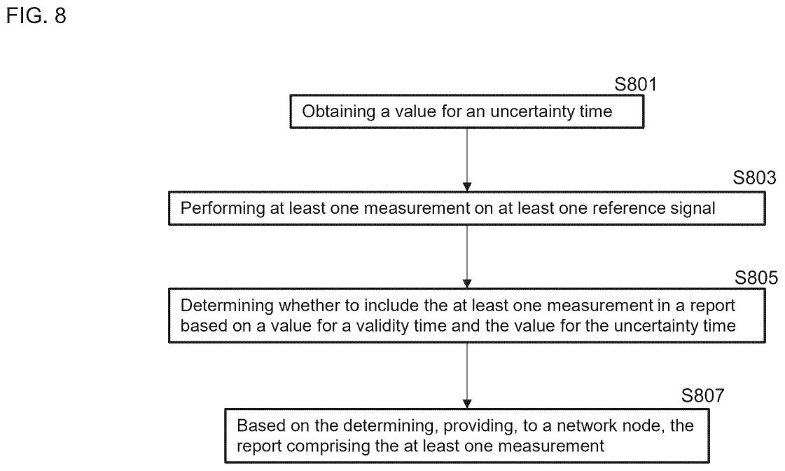

FIG. 8 shows an example method flow performed by an apparatus. The apparatus may be a communication device. For example, the apparatus may be the communication device 300 depicted in FIG. 3. Examples of a communication device include: a UE, a terminal, or other mobile device.

In S801, the method comprises: obtaining a value for an uncertainty time.

In S803, the method comprises: performing at least one measurement on at least one reference signal.

In S805, the method comprises: determining whether to include the at least one measurement in a report based on a value for a validity time and the value for the uncertainty time.

In S807, the method comprises: based on the determining, providing, to a network node, the report comprising the at least one measurement.

It should be understood that, in some examples, one or more additional method steps are included in the method flow of FIG. 8 and are performed by the apparatus. In some examples, one or more of the method steps of FIG. 8 detailed above may not be performed, or may be performed in a different order.

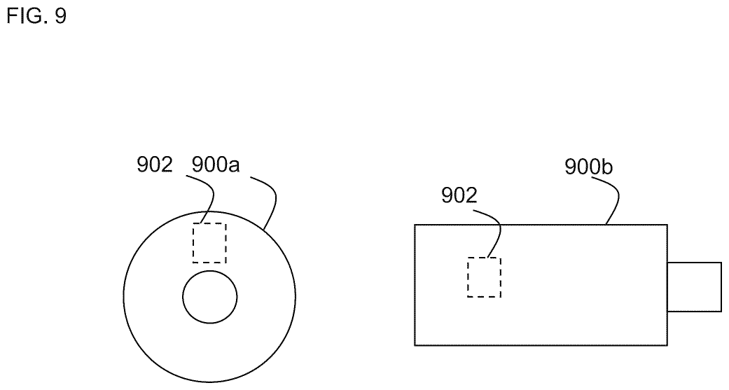

FIG. 9 shows a schematic representation of non-volatile memory media 900a (e.g. Blu-ray disc (BD), computer disc (CD) or digital versatile disc (DVD)) and 900b (e.g. flash memory, solid state memory, universal serial bus (USB) memory stick) storing instructions and/or parameters 902 which when executed by a processor allow the processor to perform one or more of the steps of the methods of FIG. 8.

It is noted that while the above describes example embodiments, there are several variations and modifications which may be made to the disclosed solution without departing from the scope of the present invention.

The examples may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The term “non-transitory”, as used herein, is a limitation of the medium itself (i.e. tangible, not a signal) as opposed to a limitation on data storage persistency (e.g. RAM vs ROM).

As used herein, “at least one of the following: <a list of two or more elements>” and “at least one of: <a list of two or more elements>” and similar wording, where the list of two or more elements are joined by “and”, or “or”, mean at least any one of the elements, or at least any two or more of the elements, or at least all of the elements.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

As used herein, the terms “means for”, “means for performing operations including”, “means configured to perform operations including”, or “means configured to perform” (or similar) may be any means that are suitable for performing the feature(s). The “means” may be configured to perform one or more of the functions and/or method steps previously described. For example, the “means” may include one or more of: at least one processor, at least one memory, transceiver circuitry, antenna circuitry, etc. It should be understood that these are provided as non-limiting examples.

Alternatively, or additionally some examples may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to uses of the term “means” in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device. The term circuitry also covers, for example and if applicable to the particular claim element, a baseband integrated circuit or processor integrated circuit for a mobile device or a similar integrated circuit in a server, a cellular network device, or other computing or network device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. A communication device comprising:
at least one processor, and
at least one memory storing instructions that, when executed by the at least one processor, cause the communication device at least to performing:
obtaining a value for an uncertainty time;
performing at least one measurement on at least one reference signal;
determining whether to include the at least one measurement in a report based on a value for a validity time and the value for the uncertainty time; and
providing, based on the determining, to a network node, the report comprising the at least one measurement.

2. The communication device according to claim 1, wherein the at least one measurement is performed while the communication device is in one of: a radio resource control, RRC, idle mode, a RRC inactive mode, or a RRC connected mode.

3. The communication device according to claim 1, wherein the communication device is further cause to perform:
receiving, from the network node, the value for the validity time.

4. The communication device according to claim 1, wherein the report comprising the at least one measurement is provided to the network node based on determining that the at least one measurement was performed within a time duration before a transmission,
wherein the time duration comprises the value for a validity time added to the value for the uncertainty time.

5. The communication device according to claim 1, wherein the transmission is performed by the communication device and comprises one of: a preamble transmission for RRC resume, a preamble transmission for RRC setup request, a msg1 transmission, a physical random access channel transmission, or a random access channel preamble transmission.

6. The communication device according to claim 1, wherein the value for the uncertainty time is representative of a time duration from a paging to a preamble transmission for the RRC resume or the RRC setup request performed by the communication device.

7. The communication device according to claim 1, wherein the value for the uncertainty time is representative of a time duration from a paging to a preamble transmission for the RRC resume or the RRC setup request that is successfully performed by the communication device.

8. A method performed by a communication device, the method comprising:
obtaining a value for an uncertainty time;
performing at least one measurement on at least one reference signal;
determining whether to include the at least one measurement in a report based on a value for a validity time and the value for the uncertainty time; and
based on the determining, providing, to a network node, the report comprising the at least one measurement.

9. The method according to claim 8, wherein the at least one measurement is performed while the communication device is in one of: a radio resource control, RRC, idle mode, a RRC inactive mode, or a RRC connected mode.

10. The method according to claim 8, wherein the method comprises:
receiving, from the network node, the value for the validity time.

11. The method according to claim 8, wherein the report comprising the at least one measurement is provided to the network node based on determining that the at least one measurement was performed within a time duration before a transmission,
wherein the time duration comprises the value for a validity time added to the value for the uncertainty time.

12. The method according to claim 8, wherein the transmission is performed by the communication device and comprises one of: a preamble transmission for RRC resume, a preamble transmission for RRC setup request, a msg1 transmission, a physical random access channel transmission, or a random access channel preamble transmission.

13. The method according to claim 8, wherein the value for the uncertainty time is representative of a time duration from a paging to a preamble transmission for the RRC resume or the RRC setup request performed by the communication device.

14. The method according to claim 8, wherein the value for the uncertainty time is representative of a time duration from a paging to a preamble transmission for the RRC resume or the RRC setup request that is successfully performed by the communication device.

15. A non-transitory computer readable medium comprising instructions, which when executed by an apparatus, cause the apparatus to perform at least the following:
obtaining a value for an uncertainty time;
performing at least one measurement on at least one reference signal;
determining whether to include the at least one measurement in a report based on a value for a validity time and the value for the uncertainty time; and
based on the determining, providing, to a network node, the report comprising the at least one measurement.

16. The non-transitory computer readable medium according to claim 15, wherein the at least one measurement is performed while the communication device is in one of: a radio resource control, RRC, idle mode, a RRC inactive mode, or a RRC connected mode.

17. The non-transitory computer readable medium according to claim 15, wherein the apparatus further cased to perform:
receiving, from the network node, the value for the validity time.

18. The non-transitory computer readable medium according to claim 15, wherein the report comprising the at least one measurement is provided to the network node based on determining that the at least one measurement was performed within a time duration before a transmission,
wherein the time duration comprises the value for a validity time added to the value for the uncertainty time.

19. The non-transitory computer readable medium according to claim 15, wherein the transmission is performed by the communication device and comprises one of: a preamble transmission for RRC resume, a preamble transmission for RRC setup request, a msg₁ transmission, a physical random access channel transmission, or a random access channel preamble transmission.

20. The non-transitory computer readable medium according to claim 15, wherein the value for the uncertainty time is representative of a time duration from a paging to a preamble transmission for the RRC resume or the RRC setup request performed by the communication device.
